(19) United States
(12) Patent Application Publication
(10) Pub. No.: US 2006/0065721 A1
(43) Pub. Date: Mar. 30, 2006

(54) System and method for a flexible point of sale terminal having a common chassis and utilizing a PC motherboard

(75) Inventors: Danny Hugh Addison, Durham, NC (US); Roger Guy Fowler, Apex, NC (US); Donald Carroll Johnson, Cary, NC (US); John David Landers JR., Raleigh, NC (US); David John Steiner, Raleigh, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 10/955,155

(22) Filed: Sep. 30, 2004

(51) Int. Cl. G06K 15/00

(52) U.S. Cl. 235/383

(57) ABSTRACT

A system and method for providing an expandable, configurable and adaptable POS terminal having a common chassis in relation to a retailer's requirements without requiring a retailer to reconfigure or swap out the logic board of the POS terminal is provided. The POS terminal of the present invention includes a common chassis forming an interior compartment for housing the internal components of the POS terminal including a PC motherboard and riser cards having POS functionality. The footprint, appearance and connectivity of the POS terminal is also adaptable to reflect retailer requirements without the need to modify or exchange the logic board of the POS terminal. Such a system and method allows for improved in-field upgrades, improvements and extensions; automatic detection of configured technology via panel cards and riser cards; coupling and mixing of a plurality of connective technologies; and customization of unique connector configurations and external preferences for a specific retail environment.

### BACKGROUND OF THE INVENTION

1. The Field of the Invention

The present invention relates in general to a system and method for providing flexible and upgradeable connections and customization with a retail computer. More particularly, the present invention relates to a system and method for providing flexible input/output (I/O) connectivity, expansive chassis options, and customer-specific chassis covers with a common chassis for a point of sale (POS) terminal.

2. Description of the Related Art

It is widely known that computer systems are used and integrated with most retail related environments. Examples of this include the use of Point of Sale (POS) devices, cash registers and inventory control devices, and various computerized systems in retail environments such as groceries, superstores and department stores. Now, it is becoming more commonplace for consumers to be offered the opportunity to use a self checkout (SCO) system, which typically comprises many of the characteristics of a POS and a checkout lane with the added benefit of allowing the consumer to conduct the checkout process.

In operation, a SCO system, similar to traditional computer checkout systems (e.g., POS) using scanning technology, uses a scanner/reader to scan a Uniform Product Code (UPC) symbol (also known as the UPC symbol) on or attached to a product intended for purchase by the consumer. The consumer scans the label using the scanner/reader and the scanner/reader recognizes the UPC symbol, converts it to computer code, communicates the converted scanned UPC code for look up with a database, locally or remotely, comprising relevant product information (“product characteristics”) such as price, weight, product description, packaging dimensions and the like, for specific characteristics about the specific product. Based on the retail environment, following look up, certain or all of the product characteristics for the specific product scanned are seemingly instantaneously communicated back to the SCO or POS. Some of these product characteristics may then be displayed to or printed for the consumer at the check out lane, while other product characteristics may be used for inventory control and reordering processes depending on the retail environment.

Once the consumer's series of purchases is complete, the SCO may subtotal the price of all of the products that were scanned, based on the product characteristic of price, and provides a subtotal amount due to the consumer, pending discounts or coupons issued via shopping cards, frequent-purchaser programs and similar loyalty-themed schemes.

Retailers often encounter a situation where their POS terminals and computer systems are in need of upgrade or additional flexibility, both due to improvements in the technology and specific needs within the retail environment. Traditionally original equipment manufacturers (OEMs) of POS terminals and systems, have designed POS terminals to be of a “closed” design, whereby there is limited opportunity for upgrades, expansion or connection options absent a detailed overhauling of the terminal itself. Partly, this is due to economic factors resulting from manufacturing efficiencies and partly as a result of technical design issues. For instance, it is difficult to separate the POS functions from a motherboard, let alone couple POS functions with traditional and more common OEM personal computer (PC) motherboards. Similarly, it is known that coordination of modifications to logical relationships as between logic boards and I/O connections typically requires extensive redesign, augmentation or “switching out” of components and logic originally part of the POS terminal.

Similarly, POS terminals are often produced based upon an OEM's design such that each POS terminal produced appears “common” and identical. Each traditional OEM POS terminal produced is typically based upon the OEM-selected particular design (e.g., version, year, part styling), composition, features and coloring without options for personalization by the customer (e.g., retailer). As a result, it is difficult and quite uncommon for an OEM to permit its design to be customized or personalized. As a result, retailers find it difficult to customize their POS terminals prior to receipt, find their POS terminals appearance to vary based on the year and model of purchase, and find their POS terminals technological compatibility to vary in accordance of the specific OEM model, year and production run.

A common result of this constraint is that any personalization of connectivity or customer-preferred features must take place in the field and requires an extensive and often unsuccessful overhaul or reconfiguration of the logic, internal components, chassis, and sometimes, the external dimensions of the POS terminal.

Typically, a tailgate (i.e. rear panel area of POS terminal having ports and connection points) will be of a particular non-modifiable design set forth based upon the internal components and logic of the POS terminal. Customization of a tailgate is rarely if ever performed by retailers; instead, where possible, retailers may involve third parties to provide spliced connections, various adaptive wiring schemes, and further connection options each of which occurs beyond the tailgate (i.e., outside the POS terminal). Further, as a result of a set OEM design offering, the production-based POS terminal typically does not permit multiple connectivity options across a common platform (e.g., universal serial bus (USB), serial I/O, etc.). For instance, most POS terminals presently used in retail environments offer only one type of dedicated I/O for POS peripherals; typically, this offering is one of RS-232, PC USB, IBM's POS Powered USB, or serial I/O (SIO), the latter being based on IBM's originally-developed technology used in the IBM 4680 POS terminal family. Similarly, with each year's production, OEMs may elect to vary design colors, appearance, and dimensions causing a retailer who purchases model offerings over a period of years, even from a common OEM, to have POS terminals that differ in technology, appearance, color and even footprint dimensions.

However, to a retailer, these production based constraints, though economically beneficial, are limitations that set forth economical and technological factors needing to be accounted for as part of a decision to purchase, finance, upgrade or avoid.

Therefore, what is needed is a method and system for providing flexibility of connectivity, chassis expansion options, and specific customer-influenced chassis cover design flexibility to retailers and users of POS terminals having a common chassis with a logic board that remains unaltered. Such a method and system should provide a means of using OEM PC motherboards for logic boards along with swappable panel covers, configuration I/O detection means, expansive chassis features and the like. Such a method and system also should allow for the consumer to pre-specify certain preferences prior to purchasing the POS terminal and should also provide retailers the flexibility to match newly ordered POS terminals with pre-existing models.

### BRIEF SUMMARY OF THE INVENTION

The present invention has been developed in response to the present state of the art, and in particular, in response to the problems and needs in the art that have not yet been fully solved by currently available retail devices and processes. Accordingly, it is an overall object of the present invention to provide an improved method and system of providing an offer presentation method to display a set of promotion opportunities, incentives and offers to shoppers via a personal shopping device in a retail environment that overcomes many or all of the above-discussed shortcomings in the art. It is a further object of the present invention to have shoppers be in communication with computer systems of the retailer so as to receive via electronically-initiated offerings, interactively and otherwise, timely and personalized shopping ideas, offerings and inducements.

To achieve the foregoing objects, and in accordance with the invention as embodied and broadly described herein, in the preferred aspects and embodiments, a system and method for a flexible POS terminal having a common chassis and utilizing PC OEM motherboards is provided for. Preferably the POS terminal of the present invention (referenced as “POS terminal” herein) is adaptable for customizing available connectivity, overall footprint dimension, and/or exterior appearance without necessitating modification or redesign to the PC motherboard or the common chassis.

In one embodiment of the present invention, a POS terminal having a formed chassis of a predetermined dimension housing internal components housed within the chassis where the internal components include a main logic board, a POS I/O panel (also used herein as “tailgate”) having a aperture at a predetermined location for receiving one or more POS I/O panel covers having panel logic, one or more PCI feature slots, one or more riser cards having active logic and at least one POS function, memory means, and a power source means is provided.

In a further embodiment of the present invention, the POS terminal has a footprint dimension of a predetermined dimensional arrangement, and is expandable to a larger footprint with the addition of a further expanded chassis having at least one dimension of width or depth, in addition to the dimension of height, approximately equal with a relational dimension of width or depth of the POS terminal.

In another embodiment of the present invention, the POS terminal further comprises a chassis that is capable of receiving chassis coverings that are of a retailer selected color, texture and appearance in view of the retailer's requirements without major rework.

In another embodiment of the present invention, a POS terminal kit is provided for.

In a further embodiment of the present invention, a method of providing a customizable POS terminal said method comprising identifying requirements for POS terminal technology, connectivity arrangements, and chassis coloring, texture and appearance requirements, and providing said POS terminal, one or panel covers having a predetermined connectivity arrangement, one or more chassis covers having a predetermined color, texture and appearance, one or more riser cards having a predetermined technology cooperatively associated with said provided panel covers and POS I/O panel, is provided.

A system and method as described above allows for improved in-field upgrades, improvements and extensions; automatic detection of configured technology via panel cards and riser cards; coupling and mixing of a plurality of connective technologies; and, customization of unique connector configurations and external preferences for a specific retail environment.

These and other objects, features, and advantages of the present invention will become more fully apparent from the following description and appended claims, or may be learned by the practice of the invention as set forth hereinafter. The above is merely a summary of the invention and thus contains, by necessity, simplifications, generalizations and omissions of detail; consequently, those skilled in the art will appreciate that the summary is illustrative only and is not intended to be comprehensive or limiting with regard to the invention at hand.

### BRIEF DESCRIPTION OF THE DRAWINGS

In order to better understand the manner in which the advantages, aspects and objects of the invention are obtained, a more particular description of the invention briefly described above will be rendered by reference to specific embodiments thereof which are illustrated in the appended drawings. Understanding that these drawings depict only typical embodiments of the invention and are not, therefore, to be interpreted to limit its scope, the invention will now be described and explained with additional specificity and detail through the use of the accompanying drawings in which:

FIG. 1 is a simplified, top, left rear perspective diagram depicting a POS terminal in accordance with a preferred embodiment of the present invention;

FIG. 2 is a simplified block diagram, indicating connection of a riser card between a POS I/O panel card according to the invention and a standard PC motherboard, and

FIG. 3 is a simplified, exploded, front left top perspective view of a POS terminal with chassis cover options in accordance with a preferred embodiment of the present invention.

### DETAILED DESCRIPTION OF THE PREFERRED EMBODIMENTS

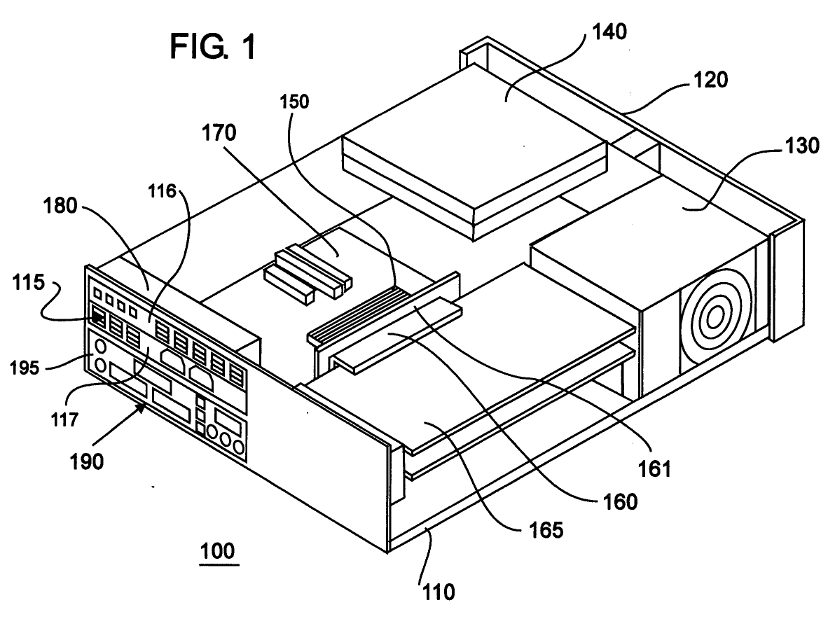

FIG. 1 is a functional block diagram depiction of a POS terminal 100 in accordance with a preferred embodiment of the present invention. The POS terminal 100 includes a chassis 110, a front portion 120, a power source 130, a memory means 140 (such as a hard drive), PCI feature slots 150, one or more riser cards 160 having active circuitry, PC motherboard 170, and a POS I/O panel card 180. The PC motherboard 170 is preferably based on the industry standard microATX based upon the envisioned footprint needs of a preferred user of the present invention. In design, the chassis of the present invention also includes an microATX-sized aperture 190 positioned at a predetermined location in the tailgate so as to receive a microATX-sized connection panel 195 for accommodating multiple varying microATX-based motherboards without necessitating a change in the chassis. Preferably, normal mounting screws are used to secure a selected microATX motherboard to the chassis at the predetermined location, and a user may reuse the same to secure a replacement, upgraded or new microATX-based motherboard within the chassis at a later time.

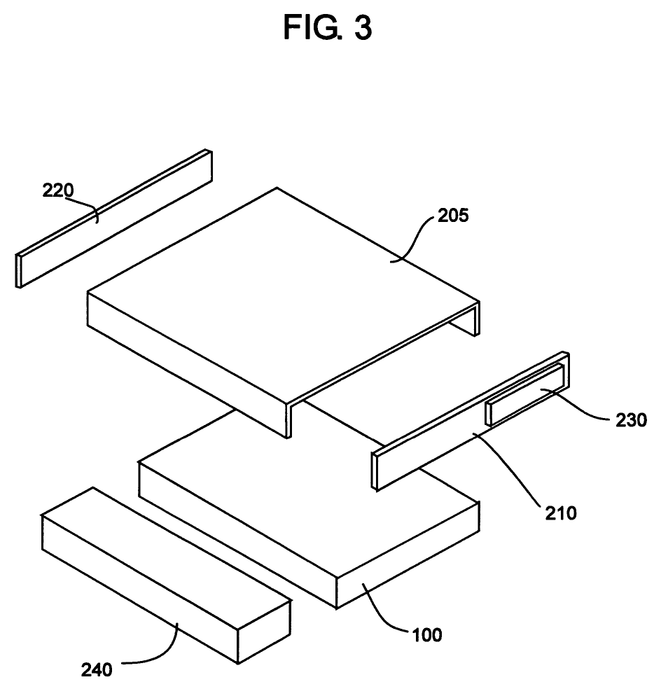

In a preferred embodiment of the present invention, the POS terminal is of a footprint dimension of 12 inches wide, 17 inches in depth, and 4 inches, tall, wherein the front portion 120 of the POS terminal is determinative of width. In a preferred embodiment, the footprint of the chassis of the POS terminal may be dimensionally increased by adding a chassis supplement which is a second chassis having at least one common dimension of width or and length, and the common dimension of height, in common with the chassis of the POS terminal of the present invention (as is discussed further below, with reference to FIG. 3). The second chassis is adaptably fittable with the chassis of the POS terminal of the present invention along the common dimension of width or length. Preferably, the second chassis is devoid of components but is capable of accommodating additional components depending on the needs of the retailer.

Preferably, the POS terminal of the present invention incorporates commonly or commercially available components, although such components are not intended to be restrictive to or limiting of the present invention.

Preferably, the PC motherboard 170 will be devoid of specific POS function but instead will be include video, Ethernet and base I/O support and connectivity. The present invention provides necessary POS function (i.e., function unique to the POS operation, non-volatile random access memory (NVRAM), etc.) via the riser card 160 such that PC feature cards 165 may be connected with the POS terminal via the PCI feature slot(s) 161 arranged on the riser card. Similarly, the riser card of the present invention, in a preferred embodiment, also includes further technology necessary for the retailer's customized needs such as: Bluetooth (for wireless connectivity), additional video adapters, RAID HDD controller, and the like. The technology present in the riser card may be augmented from time to time by the retailer based upon the retailer's needs with comparatively little impact to the POS terminal (e.g., changing the motherboard to gain additional functionality is not typically required). Functionally, for the present invention, the logic in the riser card is associated with the technology and logic of the panel card where a riser card is directly associated with a panel card. Additionally, the riser card(s) of the present invention also include active circuitry that provides the I/O connectivity to the various I/O devices to which the POS terminal may be connected.

It is envisioned that the technology capable of being supported by the riser cards and the present invention is inclusive of that previously discussed as well as that in development and discovered hereafter, as logic in a riser card is readily expanded, upgraded, replaced and/or adapted to be inclusive of new developments and protocol combinations as needed.

The POS terminal of the present invention also includes a replaceable port architecture that permits one or more POS I/O cards 180 to be communicatively connected. Preferably the POS I/O panel card 180 includes Upper and lower panels 116 and 117 having POS I/O connectors and is configured to be snapped into or out of position at predetermined locations in the chassis. Each panel card includes logic circuitry and configuration information determinative of the connectivity for the specific panel card, where the panel card is able to communicate to the riser card, as well as to devices, the specific configuration of the panel card. For instance, a panel card having one or more USB ports would include USB logic circuitry (e.g., USB hub chip) for communication of configuration information to the riser card. Beneficially, a replaceable port architecture permits a retail to readily replace panel cards, instead of an expensive planar card, where connectors on the cards fail or to upgrade for additional connectivity with minimal cost and downtime in operation.

In a preferred embodiment, the specific POS I/O cards 180 employed as part of the replaceable port architecture are identified in relation to the retailer's specific needs such that OEMs are not required to redesign the tailgates of their in-production POS terminal.

Alternatively, where a customized tailgate is required or needed in view of a specific retailer's situation, customized tailgates that are adapted for insertion of POS I/O cards 180 may also be further developed and configured with the POS terminal of the present invention. For instance, in an alternative embodiment, a retailer who has acquired SIO POS I/O cards for their present day needs for the present invention, would be able to order in the future USB POS I/O cards that could be readily configured in the future with the present invention, without affecting the chassis, motherboard or other system components of the present invention. In this alternative embodiment, a retailer could then configure certain POS terminals of the present invention to be SIO, USB or both SIO and USB, depending on how the panel cards are utilized.

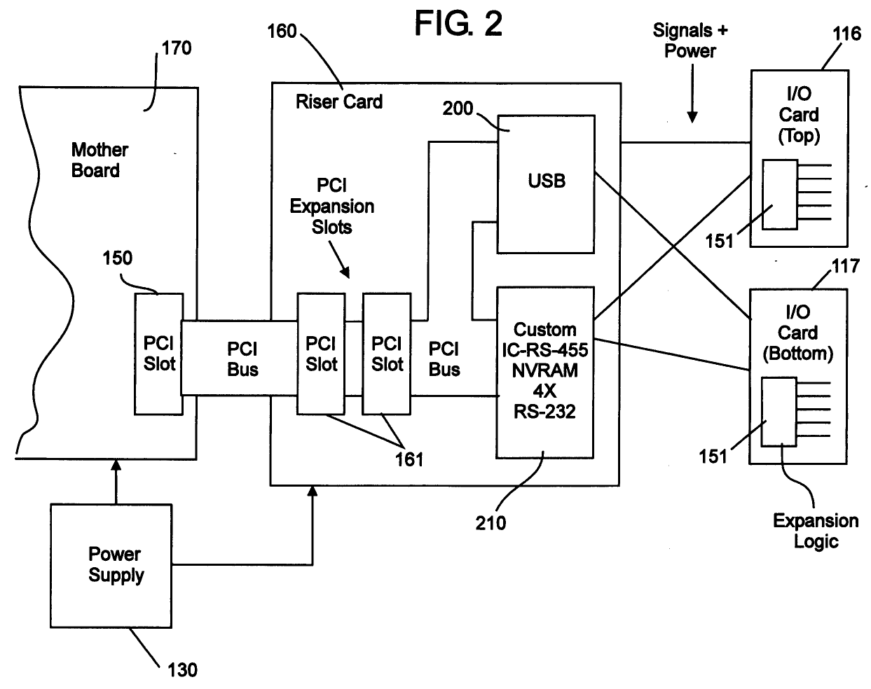

FIG. 2 shows the connection of the riser card 160 to the mother board 170 which is preferably by a card edge PCI connector. POS support 200 and 210, indicated as USB support and NVRAM respectively is located on the riser card 160 and connects to POS I/O cards or panels 116 and 117. Which are shown with expansion logic 151 which may, for example, be USB hub logic.

FIG. 3 shows a POS terminal 200 with chassis cover options 210, 220, 230 in accordance with a preferred embodiment of the present invention. In a preferred embodiment, the POS terminal 200 is provided in a common exterior of a common appearance 205 (e.g., steel, plastic, etc.) Covers 210, 220, 230 are of a color, texture, and appearance required by the retailer or reflective of options set forth by the OEMs. Similarly, decals, striping and lighting options are also envisioned as aspects available in conjunction with or on the covers. Cover 210 is a colored panel cover of a predetermined dimension fitted with the chassis 200 or an exterior shell cover of the chassis 205 of the POS terminal of the present invention. Cover 220 is a colored chassis cover of a predetermined dimension fitted with the chassis 200 of the POS terminal of the present invention. Similarly, access cover 230 is a colored chassis cover of a predetermined dimension fitted with the chassis 200 of the POS terminal of the present invention. It is envisioned that other covers, cover styles, dimensions and chassis features, beyond those specifically identified herein, are also part of the present invention.

Advantages of the present invention include providing: (1) a simpler process for in-field upgrades, improvements and extensions in retail environments without the traditional downtime or detailed reconfiguration effort; (2) automatic detection of configured technology via panel cards and riser cards; (3) coupling and mixing of a plurality of connective technologies; and (4) customization of unique connector configurations and external preferences for a specific retail environment.

Many of the functional units described in this specification have been set forth as functional block or modules, in order to more particularly emphasize their implementation independence. For example, a functional block or module may be implemented as a firmware device, hardware circuit comprising custom VLSI circuits or gate arrays, off-the-shelf semiconductors such as logic chips, transistors, or other discrete devices. A functional block or module may also be implemented in programmable hardware devices such as field programmable gate arrays, programmable array logic, programmable logic devices or the like. The present invention may include customized or off the shelf technology and products without limitation.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A POS terminal comprising:
a formed chassis of a predetermined dimension housing internal components housed within the chassis,
said internal components including a main logic board,
a POS I/O panel having a aperture at a predetermined location for receiving one or more POS I/O panel covers having panel logic,
one or more PCI feature slots,
one or more riser cards having active logic and at least one POS function,
memory means, and
a power source means.

2. The system of claim 1, wherein the main logic board is a PC motherboard.

3. The system of claim 2, wherein the PC motherboard is ATX or micro-ATX compliant.

4. The system of claim 2, wherein the active logic of the one or more riser cards and panel logic of one or more POS I/O panel cards are predetermined to be of at least one common technology or protocol.

5. The system of claim 4, wherein the common technology is SIO.

6. The system of claim 4, wherein the common technology is USB.

7. The system of claim 4, wherein the common technology minimally includes SIO and USB.

8. The system of claim 7 wherein the power source means is a power supply of a common standard with the PC motherboard, such as microATX, and the memory means includes a disk drive.

9. The system of claim 8, wherein said formed chassis further includes at least one exterior surface configured to receive at least one chassis cover.

10. The system of claim 9, wherein said at least one chassis cover is cooperatively configured to be fittably receivable and removable with said at least one exterior surface and is of a predetermined color, texture or appearance.

11. The system of claim 9, wherein said at least one chassis cover is cooperatively configured to be fittably receivable and removable over said POS I/O panel and is of a predetermined color, texture or appearance.

12. The system of claim 8, wherein said formed chassis further includes at least one exterior surface configured to receive at least one chassis expansion.

13. The system of claim 12, wherein said chassis expansion is of a dimension having a height approximately equal to height of said chassis and at least one further dimension of width or depth approximately equal to a corresponding dimension of width or depth of said chassis.

14. The system of clam 13, wherein said one exterior surface includes a receivable mount having a corresponding fitting on said chassis expansion for fittably receiving said chassis expansion with said chassis.

15. The system of claim 14, wherein the active logic of the one or more riser cards and panel logic of one or more POS I/O panel cards are predetermined to be of a plurality of common technologies or protocols including at least SIO and USB.

16. The system of claim 15, wherein said POS I/P panels are removably and automatically configurable with said active logic.

17. The system of claim 16, wherein said aperture is predetermined at a location cooperatively consistent with a connective industry standard such as ATX or microATX.

18. The method of providing a customizable POS terminal having a formed chassis of a predetermined dimension housing internal components housed within the chassis, said internal components including a main logic board, a POS I/O panel having a aperture at a predetermined location for receiving one or more POS I/O panel covers having panel logic, one or more PCI feature slots, one or more riser cards having active logic and at least one POS function, memory means, and a power source means,
said method comprising
identifying
requirements for POS terminal technology,
connectivity arrangements, and
chassis coloring, texture and appearance requirements,
and providing,
said POS terminal,
one or panel covers having a predetermined connectivity arrangement,
one or more chassis covers having a predetermined color, texture and appearance,
one or more riser cards having a predetermined technology cooperatively associated with said provided panel covers and POS I/O panel.

19. The method of claim 18, further comprising
identifying footprint requirements of said POS terminal, and
providing a chassis expansion adaptably configured to satisfy said footprint requirements when said POS terminal and said chassis expansion are coupled together.

20. A POS terminal kit comprising
instructive materials for assembly of said kit,
said kit having components readied for assembly based on a configuration determined in response to a retailerEs requirements, including: a formed chassis of a predetermined dimension housing internal components housed within the chassis, said internal components including a PC motherboard, a POS I/O panel having a aperture at a predetermined location for receiving one or more POS I/O panel covers having panel logic, one or more PCI feature slots, one or more riser cards having active logic and at least one POS function, a memory means, and a power source means, one or more panel covers, and one or more chassis covers.
